(19) United States
(12) Patent Application Publication
(10) Pub. No.: US 2002/0128019 A1
(43) Pub. Date: Sep. 12, 2002

(54) Online location finding system and method based on information extracted from a cellular mobile unit

(76) Inventors: Igal Ben-Yair, Ramat Hasharon (IL); Shmuel Weiss, Savyon (IL); Yair Porat, Tel Aviv (IL); Yehuda Riron, Petach Tikva (IL); Lucien Geldzhaler, Ra' anana (IL)

Correspondence Address: Edward Langer, Pat. Atty., c/o Landon & Stark Associates, One Crystal Park, Suite 210, 2011 Crystal Drive, Arlington, VA, 22202, US

(21) Appl. No.: 09/985,182

(22) Filed: Nov. 1, 2001

Related U.S. Application Data
(60) Provisional application No. 60/245,395, filed on Nov. 1, 2000.

(51) Int. Cl. H04Q 7/20

(52) U.S. Cl. 455/456; 455/422

(57) ABSTRACT

A location finding system (100) includes a cellular mobile unit (102) a microprocessor (104) with communication port (106) and a remote dedicated server (108) connected via online data connection to the microprocessor (104). The system (100) can compute the mobile units (102) location in a very accurate way, using data which has been extracted from the mobile unit (102) by the microprocessor (104) without the need to Install any further hardware or software components Into the cellular network infrastructure. The location finding system operates based on the fact that in cellular systems, the cellular base station updates the cellular mobile unit (102) with the network's parameters. These include the ID of the current cell (112) to which the unit is connected, the ID and antenna sector of some neighbor cells (114) and the received signal strength, as measured by the mobile unit. Based on those parameters, and some other data related to the cellular networks the remote dedicated server (108), running a smart algorithm, can make a calculation of the mobile unit's location.

### FIELD OF THE INVENTION

This invention relates generally to location finding of a battery operated transceiver device, and more specifically, to an online system and method continuously able to find the location of a subscriber that Is using a cellular mobile unit.

### BACKGROUND OF THE INVENTION

Cellular communication systems provide more and more services for their subscribers as an added value for their subscription fee, one of which is a location service. Using such information can be useful for the subscriber to receive direction guidance in a non-familiar urban zone, another feature is to become a substitute for a Global Positioning System (GPS) system in a dense populated area where the GPS signal are often blocked by buildings and bridges.

The need for finding the location of a mobile unit in a cellular network is also essential for emergency services (e.g., 911 service in the U.S.A.), as well as for numerous commercial applications and security applications to determine user authorization. The algorithms used in Calculations for finding the location are known in the art, but current systems depend on establishing communications with mobile units, which are generally not in use, and therefore require being called and answering the call. Recently third generation cellular phones have been Introduced, which are continuously in online contact, like the Internet, such as UMTS, EDGE and GPRS technologies.

Thus, the need exists to be able communicate with a mobile unit without first having to establishing contact, for the purpose of determining the location of the mobile unit.

### SUMMARY OF THE INVENTION

It is a basic objective of the present invention to achieve an accurate location finding system for battery powered devices, which communicate through a cellular network, and particularly to provide a cellular phone application vendor the ability to locate every user and to provide him an add-on services (e.g., such as direction guidance).

The location process could be done without the need to have any formal relation with the cellular network administrator Furthermore, the location process does not acquire any need of installing hardware or software to the cellular network infrastructure, drastically reduces the costs, complexity and implementation time.

Further, the system can obtain very accurate readings of the user's position In heavily populated areas, since usually in such areas there are many cellular phones located In a small area in close proximity with each other.

Another object of the invention is to provide a location finding system which will suit all the methods of the cellular communication system known today, such as Global system for Mobile (GSM), Code Division Multiple Access (CDMA) and Time Division Multiple Access (TDMA), and which will easily be implemented in every future cellular standard, such as any 3G standards, e.g., GPRS, UMTS and EDGE.

Furthermore, this invention enables the user to activate/deactivate the location system, obviating the issue of privacy issue, usually raised in such a service.

Other features and advantages of the present invention will become apparent from the following drawings and description.

### BRIEF DESCRIPTION OF THE DRAWINGS

For a better understanding of the invention with regard to the embodiments thereof, reference is made to the accompanying drawings, In which like numerals designate corresponding elements or sections throughout, and in which;

FIG. 1 is a block diagram of a location finding system for a mobile cellular phone, constructed and operated In accordance with the principles of the present invention; and

FIG. 2 is a schematic Illustration of the system of FIG. 1, depicting the use of the current cell's antenna sector to obtain the angle of arrival (AOA), and by adding Its calculated distance from the mobile unit (if known), a first location result may be derived.

### DETAILED DESCRIPTION OF THE INVENTION

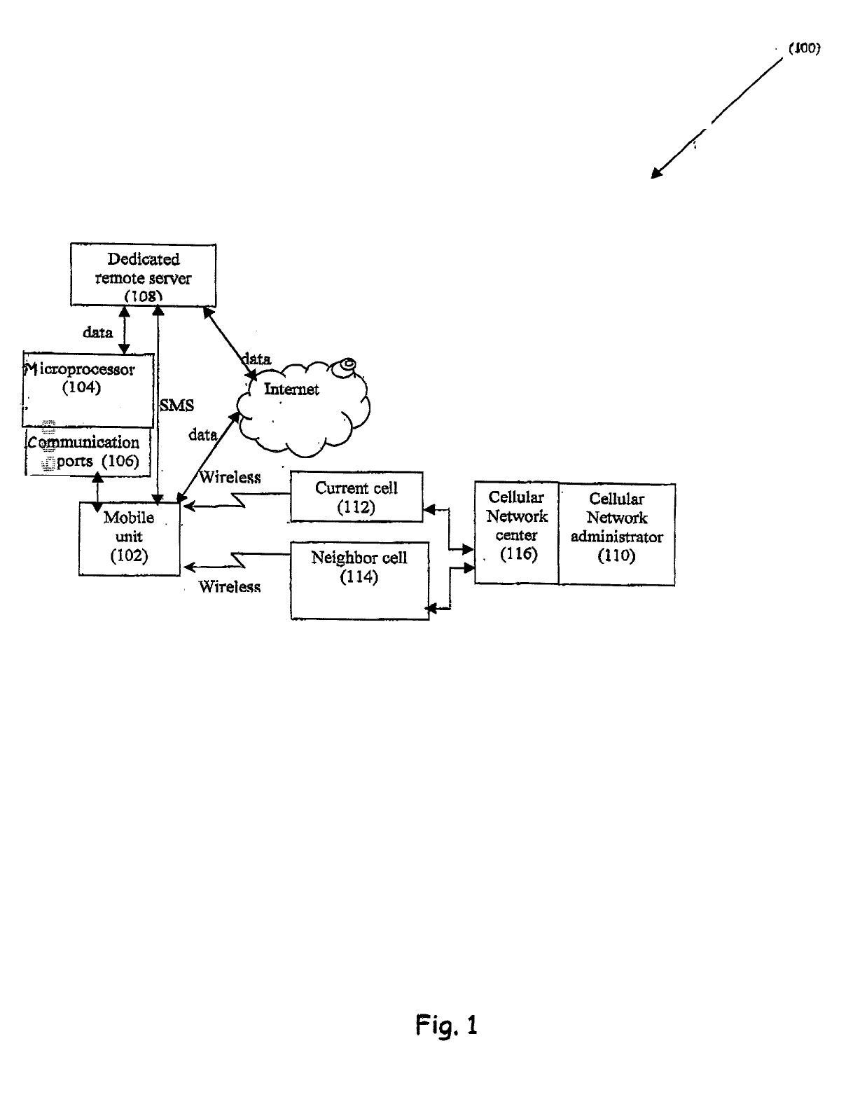

With reference now to FIG. 1, which is a block diagram of a location finding system for a mobile cellular phone, constructed and operated in accordance with the principles of the present invention, a location finding system (100) is shown. Location finding system (100) includes a cellular mobile unit (102) a microprocessor (104) with communication ports (106) in which it may construct a two-way communication with the mobile unit (102) as well as to a remote dedicated server (108) using on-line data connection (e.g. such as using the Internet).

The microprocessor (104) has a data link (one or more ) to the cellular mobile unit (102) using:

1. direct connection using mobile data port;

2. wireless connection (such as Bluetooth);

3. Infra-Red (IR) connection:

4. 802.11 standards

5. direct connection using on board lines (such as internal bus); and

6. any other method.

The microprocessor (104) can reside in any of the following apparatii:

1. a separate enclosure detachably coupled to the mobile unit;

2. a smart card (such as a SIM card) located in a dedicated slot inside the mobile device;

3. a separate battery operated device wirelessly connected to the mobile device; and

4. any other.

A Subscriber Identity Module (SIM) card is designed for insertion into a mobile telephone. A SIM or “smart” card contains all subscriber-related data, such as phone numbers, service details and memory for storing messages. With a SIM card calls can be made from any valid mobile phone because the subscriber data, and not the telephone's internal serial number, is used to make the call.

In reference to FIG. 1, when the mobile unit turns on, it starts monitoring the signals it receives from any cellular cells nearby. The strongest signal it receives, after negotiation with the network administrator (116), comes from the current cell (112). A mobile unit (102) located within a close range with a current cell (112), communicate wirelessly with it. Furthermore, the mobile unit (102) may receive signals from other neighbor cells (114).

Current cell (112) updates the mobile unit (102) as to its ID number and which antenna sector it uses (each sector is usually 120 wide), and so do neighbor cells (114). Mobile unit (102) also monitors the signal strength it receives from the current cell and the neighbor cells. When the user moves physically into another cell zone, the current cell wall hand off to the new cell, which becomes the current cell (112). As for the previous cell. it becomes a neighbor cell (114).

Once the microprocessor (104) establishes a connection with mobile unit (102), using a standard protocol (such as AT commands or 3-wire protocol), it constantly monitor the ID, the antenna sector and the signal strength of the current cell. An AT command is an instruction sent to a modem with the prefix AT.

The microprocessor may use standard AT commands such as AT+CSQ (signal quality) to monitor received signal strength Indicator <rssi> in dBm (decibel power based on milliwatts), ATˆ MONI (monitor idle mode and dedicated mode) to monitor current cell ID number, location area ID, and receiving level (in dBm) and ATˆ MONP (monitor neighbor cells) for the same parameter on neighbor cells, or any other standard commands that will be defined according to the communication technology, or by the handset manufacturer Following that, the microprocessor stores the data in memory.

In cellular networks that use Code Division Multiple Access (CDMA) it is possible to get such data directly from the mobile unit, on neighbor cells (114), as this method relies on connection to three cells simultaneously.

In Global System for Mobile (GSM) and Time Division Multiple Access (TDMA) networks, only the current cell is accessed. However, monitoring the current cell data over time usually reveals all the neighbor cell ID's and their antenna sector. This happens when an automatic hand-over is initiated by the network, or when a multipath phenomena happens and another cell becomes the current cell, or when the user moves to another location nearby which belongs to other cell.

After that, when a location finding is needed, microprocessor (104) establishes a date link to the remote dedicated server (108), it may do so by contacting mobile unit (102) itself, using the cellular infrastructure (e.g. to connect to the Internet) or it may choose other methods to connect to the server (such as an analog modem through a voice channel,

The server (108) should have been once updated with the cellular cell locations, their antenna sector partition and if possible, their transmission power. After that, it is preferable to be constantly updated with the position and transmission power of every cellular cell, which belongs to the cellular network. In a specified zone where the location finding services are applied. This knowledge is a crucial element in location finding system (100), falling to obtain an accurate and updated data on the cells parameters would result in a poor location findings results.

The cell's location information could be collected without having any agreement with the cellular network administrator (110) at cellular network center (116), although it is preferable. It could be done visually, by moving around the desired area with a Global Positioning System (GPS) device, mapping each cellular base station in sight, using a cellular phone to read the cell's ID and antenna sector. GPS is a system for determining position on the Earth's surface by comparing radio signals from several satellites. Depending on your geographic location, the GPS receiver samples data from up to six satellites, it then calculates the time taken for each satellite signal to reach the GPS receiver, and from the difference in time of reception, determines your location.

The server receives information regarding current cell (112) and neighbor cell (114), i.e., ID number, cell sector and received signal strength, which are sent from microprocessor (104). Combining these with the data on every cell's exact location and transmission strength (if known) with a further knowledge of the mobile unit's antenna gain and Its power meter accuracy, a calculation could be made for obtaining Angle of arrival (AOA) and an approximate distance of the mobile unit from each cell it receives (if transmission power Is known).

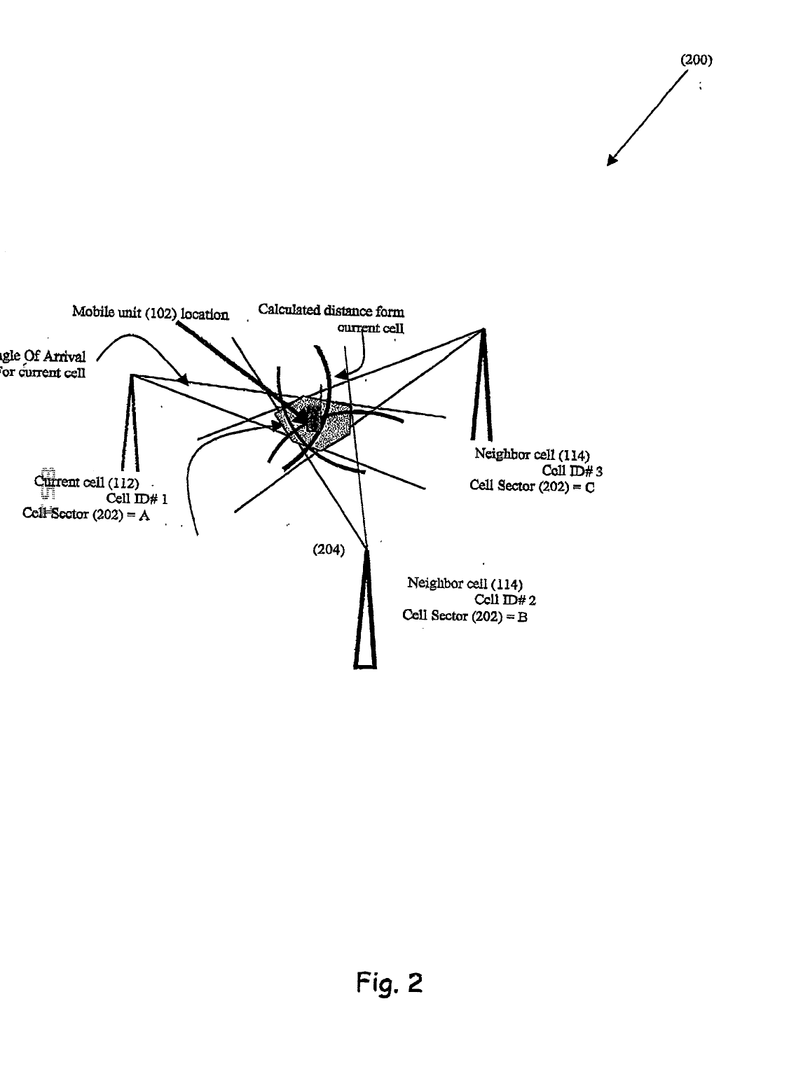

In reference to FIG. 2, using the current cell's antenna sector to obtain the angle of arrival (AOA), and by adding its calculated distance from the mobile unit (if known), a first location result may be derived.

Using the antenna sector of all the cells participating (current and neighbors) a more accurate cross section of all of the AOA's involve may now be derived. Adding the calculated distance from every cell (if known) an even more accurate result is achieved. The location results may be sent back to microprocessor (104) to be stored in is memory for obtaining a log of location finding results over a long period of time.

The user of the mobile unit can switch on and off (e.g., by a dedicated software or hardware switch) the collection of the location data. This solves the privacy Issue, which can be an obstacle for this service.

FIG. 2 is a schematic illustration for location finding (200) using cross section and cross distances. FIG. 2 shows that every cell participating in the location process has a cell sector (202) from which mobile unit (102) receives its transmission. These three sectors provide a cross section (204) in which mobile unit (102) resides. A second, and more precise. location could be determined by crossing the lines of calculated distances at which mobile unit (102) is placed from each cell.

Having described the invention with regard to certain specific embodiments, it is to be understood that the description is not meant as a limitation, since further modifications may now suggest themselves to those skilled in the art, and it is intended to cover such modifications as fall within the scope of the appended claims.

We claim:

1. A system for determining the location of a mobile cellular unit of a cellular network, having a wireless communication standard and having a plurality of cells, each cell having an antenna, the system comprising:
a mobile cellular unit;
a current cell of the cellular network from which the mobile cellular unit receives the strongest signal via the antenna;
a dedicated server, and
a microprocessor in online communication with said dedicated server for controlling communications and applying algorithms used to calculate the location of said mobile cellular unit In continuously available fashion.

2. The system according to claim 1, wherein the mobile cellular unit is connected to an electronic network.

3. The system according to claim 2, wherein the electronic network is the Internet.

4. The system according to claim 1, wherein the cellular network is Global System for Mobile (GSM).

5. The system according to claim 1, wherein the cellular network is Code Division Multiple Access (CDMA),

6. The system according to claim 1, wherein the cellular network is Time Division Multiple Access (TDMA).

7. The system according to claim 1, wherein said microprocessor resides in a separate enclosure.

8. The system according to claim 1, wherein said microprocessor resides in a smart card.

9. The system according to claim 8, wherein said microprocessor resides in a Subscriber Identity Module (SIM) card.

10. The system according to claim 1, wherein the cellular network has a wireless communication standard such as UMTS, GPRS, EDGE or HDCD.

11. A method for determining the location of a mobile cellular unit associated with a user, the mobile cellular unit being part of a cellular network having a wireless communication standard and having a plurality of cells, each cell having an antenna, said method comprising:
providing a location finding system comprising:
a mobile cellular unit;
a current cell of the cellular network from which the mobile cellular unit receives the strongest signal via the antenna;
a dedicated server; and
a microprocessor in online communication with said dedicated server for controlling communications and applying algorithms used to calculate the location of said mobile cellular unit in continuously available fashion,
establishing communication with the mobile cellular unit by said microprocessor via the continuously available online connections;
storing information from the mobile cellular unit by said microprocessor, said information comprising at least one of the following from at least one cell (the current cell) of the cellular network:
received signal strength;
ID number;
antenna sector; and
location area ID;
calculating the angle of arrival of the at least one cell;
calculating the distance from the mobile cellular unit to the antenna of the at least one cell; and
determining the location of the mobile cellular unit.

12. The method according to claim 11, further comprising using the antenna sector of at least three cells to calculate at least three angles of arrival, and thereby to calculate the location of the mobile cellular unit more accurately.

13. The method according to claim 11, further comprising calculating the distance from at least three cells to calculate the location of the mobile cellular unit more accurately.

14. The method according to claim 11, further comprising switching off collection of said location area ID by the user.
